(19) United States
(12) Patent Application Publication
(10) Pub. No.: US 2006/0150837 A1
(43) Pub. Date: Jul. 13, 2006

(54) Printing machine and method for printing a print web

(76) Inventors: Klaus Thimm, Northeim (DE); Wolfgang Becker, Northeim (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/541,575

(22) PCT Filed: Dec. 30, 2003
(86) PCT No.: PCT/DE03/04258

§ 371 Date: Jul. 7, 2005

(30) Foreign Application Priority Data
Jan. 8, 2003 (DE) 103005021

(51) Int. Cl. B41F 5/18

(52) U.S. Cl. 101/178

(57) ABSTRACT

In order to print a print web (1) by means of a plurality of printing groups (5), the print web (1) is guided in the region of the printing groups (5) on a support band (10) which is transported at the same speed and multiple printing is carried out by printing groups (5) arranged next to each other in the direction of transport of the support band (10). Preferably, the printing groups (5) are arranged on vertical machine stands (6), which are disposed near to each other and parallel to each other, and terminate with plate cylinders (7) at the same level, thereby enabling the print web (1) to run through a print zone (3) in a substantially horizontal manner.

The invention relates to a method for printing a print web by means of a plurality of printing units.

The invention also relates to a printing machine having a plurality of printing units, which each have a circulating printing belt carrying a printing plate and guided around a plate cylinder and an ink applicator device, and having a print web guidance system with rollers and pressing devices for pressing the print web onto the printing belt.

The printing of print webs, in particular paper webs, is regularly carried out by the paper web being led into various printing units in the form of a loop, a deflection through, for example, 180° regularly taking place at the transition from one printing unit to another.

For the printing of smaller editions, such as is frequently needed for printed packages, flexographic printing machines have proven worthwhile, as are disclosed, for example, by DE 44 10 132 C2. In this case, the printing plate is located as a flexible material on a circulating printing belt which is guided over a printing cylinder, the print web being printed in interaction with an impression cylinder as it runs through between the two cylinders.

The known printing methods have proven worthwhile and can be used without difficulty in the case of print webs which have adequate stability under tension, in order to absorb the tensile forces exerted on the print web running freely between deflection cylinders as the print web runs through cylinder nips of driven cylinders.

The known printing methods of this type are problematical for print webs having a lower inherent stability and/or in particular greater elasticity, which means that higher tensile forces may not be applied.

For the printing of print webs of this type, it is known to provide a large central cylinder, over the circumference of which the printing units are distributed. For the printing operation, the print web is transported on the circumference of the central roll without any relative speed and is printed in the process. In this way, the printing even of print webs with a low inherent stability is successful, but at the expense of considerable disadvantages. When a central cylinder is used, hitherto no belt printing units could be used, since the printing units have to be arranged radially, as seen from the central cylinder, and are thus aligned differently. In addition, the circulating printing belts, tensioned by a tensioning roll, therefore exert different forces on the inherent weight, which leads to different printing results in the various printing units. When conventional printing cylinders are used, if the size of the print repeat is changed, the printing cylinders have to be changed. In addition, the printing cylinders permit repeat lengths of only up to 2.5 m, while considerably greater repeat lengths can be implemented with printing belts.

By contrast, the invention is based on the object of permitting printing of a print web, even with a lower inherent stability, by means of a plurality of printing units with a printing machine which is simply constructed and can be changed flexibly.

In order to solve this problem, according to the invention a method of the type mentioned at the beginning is characterized in that the print web is guided in the region of the printing units on a supporting belt transported at the same speed, and in that the multiple printing is carried out by means of the printing units arranged beside one another in the transport direction of the supporting belt.

The method according to the invention permits the use in particular of belt printing units which, because of their ability to be used flexibly, bring considerable advantages with them. The printing even of print webs having low inherent stability and/or greater elasticity succeeds as a result of the fact that the print web is transported in the region of the printing units together with a supporting belt, in relation to which the print web has no relative speed, so that the print web is supported flat at all times over the transport path through the printing units. Given preferred, substantially rectilinear, guidance of the supporting belt, no stresses produced by a deflecting movement on various radii are exerted on the print web. In a further preferred embodiment, the guidance of the print web is ideally rectilinear. Substantially rectilinear guidance in the sense of this application is present even when relatively small deflections of less than 45°, preferably less than 20°, occur. Slight deflections within the aforementioned limits are not prejudicial to the present invention.

The printing is preferably carried out at equal intervals, that is to say equidistantly in the transport direction.

The present invention is preferably used when printing from roll to roll. However, it is also possible to divide the print web immediately into suitable web sections after printing.

The method according to the invention permits an advantageous arrangement of the printing units parallel to one another, preferably in parallel stands of a printing machine. As a result, the printing units are accessible in a straightforward manner for maintenance work or for a print change. Any new installations of the flexographic printing unit can be carried out in a simple way without difficulties. If the print web runs rectilinearly, preferably above the plate cylinders, the accessibility to the printing units is not hampered by the course of the print web.

In order to solve the above-mentioned problem, therefore, a printing machine of the type mentioned at the beginning is also characterized in that the print web guidance through the printing units is formed by a supporting belt moved at the speed of the print web, and that the printing units are constructed on machine stands aligned along the supporting belt, the supporting belt preferably running substantially rectilinearly.

In this case, the printing units are preferably mounted on machine stands which are arranged in parallel, the plate cylinders of the printing units are arranged at the same height in the printing state, and a substantially horizontal course of the supporting belt above the plate cylinders is provided.

The supporting belt can circulate on supporting rollers, the supporting rollers for supporting the print web preferably being arranged close together. Other supporting devices can likewise be used, such as glide plates.

In an advantageous embodiment of the printing machine according to the invention, in each case an impression cylinder is arranged opposite the plate cylinders and is preferably aligned tangentially with the supporting rollers, so that a rectilinear course of the supporting belt can also be maintained in the region of the impression cylinder. The print web runs on the side of the supporting belt facing away from the impression cylinder.

The printing units can be set up to accommodate printing belts of different lengths, that is to say can in particular be flexographic printing units.

The supporting belt is expediently driven without slipping and is preferably constructed so as to form a form fit with a drive element.

The invention is to be explained in more detail in the following text by using an exemplary embodiment illustrated in the drawing, in which:

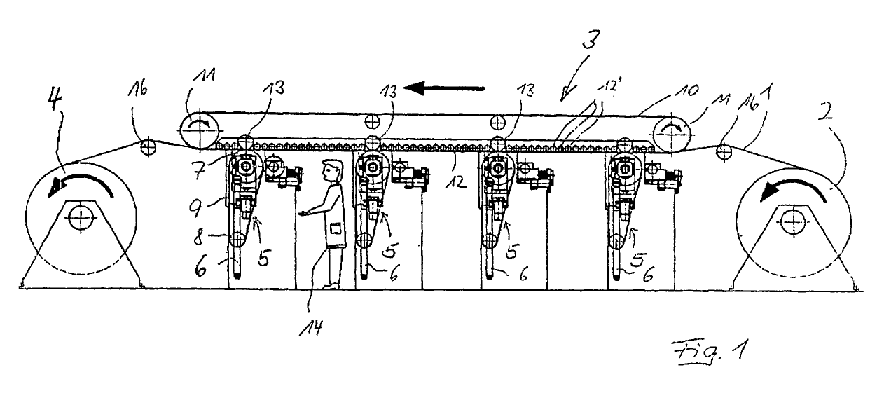

FIG. 1 shows a schematic side view of a printing machine according to the invention for printing a print web from roll to roll and having four printing units

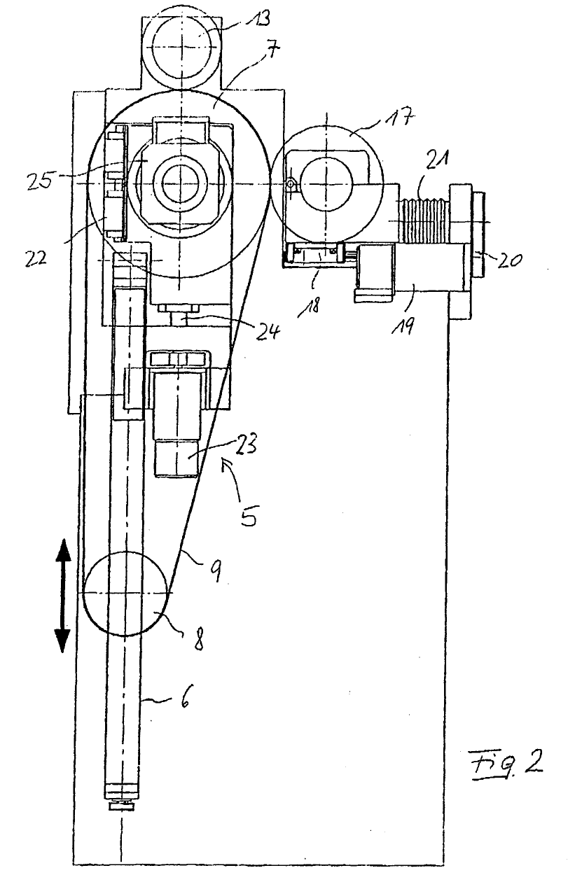

FIG. 2 shows an enlarged illustration of one of the printing units provided in FIG. 1.

In the illustration of FIG. 1, a print web 1 runs from a supply roll 2 into a printing zone 3 and, in the printed state, is wound up onto a wound roll 4. In the printing zone 3 there are four printing units 5, which are fixed to vertical stands 6 as belt printing units. Each printing unit 5 thus has a printing belt 9 circulating endlessly over a plate cylinder 7 and a tensioning roll 8 and on which flexible plates forming the printing plate are fixed.

In the printing state, the plate cylinders 7 are all located at the same height, so that the print web 1 runs horizontally over the respective horizontal tangent to the plate cylinders 7.

In the printing zone 3, that is to say in the region of the printing units 5, the print web 1 runs through the printing units 5 together with a supporting belt 10. The supporting belt 10 circulates endlessly between two deflection rollers 11, with a lower run 12 running horizontally. The print web bears against the lower run 12 running horizontally and is moved at the same web speed as the supporting belt 10. From the side of the lower run 12 opposite the print web 1, in the region of the plate cylinders 7, in each case an impression cylinder 13 arranged in a fixed location presses against the lower run 12 and the print web 1. As it runs through the nip between plate cylinder 7 and impression cylinder 13, the print web 1 is printed.

In FIG. 1, an operator 14 shown schematically illustrates the fact that the interspace between the printing units 5 can be entered conveniently, so that the printing units 5 are accessible conveniently and without difficulties for maintenance and set-up purposes.

The supporting belt 10 is supported in the region of its lower run 12 on the side opposite the print web 1 by supporting rollers 12′ lying close together in the transport direction and kept in contact with the print web 1. The contact with the print web 1 is intensified by the fact that the print web 1, before it enters the printing zone 3 and after it leaves the printing zone 3, is guided over deflection rollers 16, by means of which the print web is deflected slightly upward over the distance between deflection roller 16 and the associated deflection roller 11 of the circulating printing belt 10, at an angle of <10° with respect to the horizontal course through the printing zone 3.

FIG. 2 shows, in a schematic illustration, the construction of a printing unit 5. A vertical double arrow indicates the fact that the lower tensioning roll 8 can be moved in the vertical direction on the vertical stand 6 in order to tension the circulating printing belt 9. The printing operation takes place in the nip between plate cylinder 7 and impression cylinder 13, through which the printing belt 9 but also the arrangement comprising print web 1 and lower run 12 of the supporting belt 10 run. Before the printing belt 9 enters the aforementioned nip between plate cylinder 7 and impression cylinder 13, ink is applied in the desired quantity to the outside of the printing belt 9 or a plate fitted to the latter by an ink applicator roll 17. For this purpose, the ink applicator roll 17, formed as an engraved roll with a linear guide 18, can be set against the circumference of the plate cylinder 7 by means of a servo motor 19. The setting of the ink applicator roll 17 is carried out by means of a spindle (not illustrated) driven by means of a belt drive 20 and guided within a bellows 21. The rotational drive of the ink applicator roll 17 is provided via a controlled-speed servo motor, not illustrated.

In a corresponding way, the plate cylinder 7 can be pressed against the fixed-location impression roll 13 by means of a linear guide 22 and a servo motor 23 and via a spindle 24. The rotational movement of the plate cylinder 7 is effected by a controlled-speed servo motor 25.

The printing unit illustrated, in conjunction with the arrangement illustrated in FIG. 1, is suitable in particular for printing large print repeats. The print repeat can be changed quickly and in an uncomplicated manner by replacing the printing belt 9 with a printing belt 9 of a different length. As a result of the vertically displaceable tensioning roll 8, firstly a replacement is readily possible and, secondly, the necessary tension can be set quickly again.

The printing machine according to the invention is therefore distinguished by high flexibility, in that rapid conversion of the printing machine to a different print repeat is possible.

1. A method for printing a print web (1) by means of a plurality of printing units (5), characterized in that the print web (1) is guided in the region of the printing units (5) on a supporting belt (10) transported at the same speed, and in that the multiple printing is carried out by means of the printing units (5) arranged beside one another in the transport direction of the supporting belt (10).

2. The method as claimed in claim 1, characterized in that the printing is carried out equidistantly in the transport direction.

3. The method as claimed in claim 1,
characterized in that the printing is carried out from roll (2) to roll (4).

4. The method as claimed in claim 1,
characterized in that the supporting belt (10) is guided substantially rectilinearly.

5. The method as claimed in claim 1,
characterized in that, in the printing unit (5), the print web (1) with the supporting belt (10) is transported through between a plate cylinder (7) and an impression cylinder (13), the print web (1) being guided on the side of the supporting belt (10) facing away from the impression cylinder (13).

6. The method as claimed in claim 1,
characterized in that the supporting belt (10) is guided over supporting rollers (12′) arranged in a fixed location.

7. The method as claimed in claim 6, characterized in that the supporting rollers (12′) are arranged close together.

8. A printing machine having a plurality of printing units (5), which each have a circulating printing belt (9) carrying a printing plate and a printing belt (9) guided around a plate cylinder (7) and an ink applicator device (17), and having a print web guidance system with rollers and pressing devices (13) for pressing the print web (1) onto the printing belt (9) with the printing plate, characterized in that the print web guidance through the printing units (5) is formed by a supporting belt (10) moved at the speed of the print web (1), and that the printing units (5) are constructed on machine stands (6) aligned along the supporting belt (10), the supporting belt preferably running substantially rectilinearly.

9. The printing machine as claimed in claim 8, characterized in that the supporting belt runs substantially rectilinearly.

10. The printing machine as claimed in claim 9, characterized in that the printing units (5) are mounted on machine stands (6) which are arranged in parallel, in that the plate cylinders (7) of the printing units (5) are arranged at the same height in the printing state, and in that the supporting belt (10) runs substantially horizontally above the plate cylinders (7).

11. The printing machine as claimed in claim 8, characterized in that the supporting belt (10) circulates over supporting rollers (12′).

12. The printing machine as claimed in claim 11, characterized in that the supporting rollers (12′) are arranged close together.

13. The printing machine as claimed in claim 8, characterized in that in each case an impression cylinder (13) is arranged opposite the plate cylinders (7).

14. The printing machine as claimed in claim 13, characterized in that the impression cylinder (13) is aligned tangentially with the supporting rollers (12′).

15. The printing machine as claimed in claim 13,
characterized in that the print web (1) is guided through the printing unit (5) with the supporting belt (10) on the side facing away from the impression cylinder (13).

16. The printing machine as claimed in claim 8, characterized in that the printing units (5) are set up to accommodate printing belts (9) of different lengths.

17. The printing machine as claimed in claim 8, characterized by a slip-free drive of the supporting belt.
